(19) United States
(12) Patent Application Publication
(10) Pub. No.: US 2012/0072232 A1
(43) Pub. Date: Mar. 22, 2012

(54) Systems and Methods for Using Online Resources to Design a Clinical Study and Recruit Participants

(76) Inventors: Patrick Frankham, Montreal (CA); Wolfgang Renz, Montreal (CA); Tony Nimeh, Montreal (CA); Mounir Hilal, Montreal (CA); Rami Fahim, Montreal (CA); Maleek Jamal, Toronto (CA)

(21) Appl. No.: 13/095,676

(22) Filed: Apr. 27, 2011

Related U.S. Application Data
(60) Provisional application No. 61/329,041, filed on Apr. 28, 2010.

(51) Int. Cl. G06Q 50/22

(52) U.S. Cl. 705/2

(57) ABSTRACT

The present application is directed to methods and systems for tapping online resources to design a clinical trial and/or recruit participants for the clinical trial. In one embodiment, a system for using online resources to design a clinical trial and/or recruit participants includes one or more web crawlers. Each of the web crawler may be configured to collect data related to one or more specified topics during a community identification phase. A data engine of the system processes the collected data into filtered, relevant information that identifies communities of individuals suitable for recruitment. A patient discovery module may, in a patient discovery phase, develop or use a survey to further target interested patients for recruitment and collect information for designing a suitable study or trial. The system may, in an assessment and communication phase, design a study which may be self-managed by the recruited patients. The study may provide feedback for refining or modifying any one of the above phases. The study may also aim to address certain issues faced by the recruited patients, such as ensuring compliant use of a drug, elimination of side-effects, and using a modified therapy to improve the effectiveness of a drug, etc.

### RELATED APPLICATION

This application claims the benefit of and priority to U.S. Provisional Application No. 61/329,041, entitled “SYSTEMS AND METHODS FOR USING ONLINE RESOURCES TO DESIGN A CLINICAL STUDY AND RECRUIT PARTICIPANTS ” and filed on Apr. 28, 2010, which is incorporated herein by reference in its entirety.

### FIELD OF THE DISCLOSURE

This disclosure generally relates to systems and methods for implementing a clinical study. In particular, this disclosure relates to systems and methods for using online resources to design a clinical trial and to identify and recruit participants for the clinical trial.

### BACKGROUND OF THE DISCLOSURE

Individuals are increasingly turning to the Web for obtaining and/or sharing health information. The proliferation of health and/or medical related websites, blogs, and discussion boards provide avenues for individuals to proactively participate in their own well-being, e.g., generally educating themselves, looking for specific answers, sharing personal experiences, or warning and informing others with respect to certain health or medical issues. Such online resources may provide a wealth of information about patient concerns, patient profiles, and therapeutic effectiveness and benefit as reported by patients themselves.

### BRIEF SUMMARY OF THE DISCLOSURE

The present application is directed to methods and systems for tapping online resources to design a clinical trial and/or recruit participants for a product assessment, such as a drug assessment or a clinical trial. In one embodiment, a system for using online resources to design a clinical trial and/or recruit participants includes one or more web crawlers. Each of the web crawler may be configured to collect data related to one or more specified topics during a community identification phase. A data engine of the system processes the collected data into filtered, relevant information that identifies communities of individuals suitable for recruitment. A patient discovery module may, in a patient discovery phase, develop or use a survey to further target interested patients for recruitment and collect information for designing a suitable study or trial. The system may, in an assessment and communication phase, design a study which may be self-managed by the recruited patients. The study may provide feedback for refining or modifying any one of the above phases. The study may also aim to address certain issues faced by the recruited patients, such as ensuring compliant use of a drug, elimination of side-effects, and using a modified therapy to improve the effectiveness of a drug, etc.

In some aspects, the present solution is directed to a method for identifying one or more online communities comprising discussions related to patients use of a predetermined drug. The method includes determining, by a device, a plurality of keywords corresponding to a predetermined drug and use of the predetermined drug. The device obtains a list of web sites that have one or more online communities comprising discussions generated from web site users about use of one or more drugs; The device crawls each web site in the list of web sites to match discussions among users within each web site to the plurality of keywords corresponding to the predetermined drug and use of the predetermined drug. The method also includes identifying, by the device, one or more online communities from the list of web sites that have patient generated discussions corresponding to the predetermined drug and the use of the predetermined drug.

In some embodiments, the method includes determining a keyword of the plurality of keywords that describes a side-effect of the use of the predetermined drug. In some embodiments, the method includes determining a keyword of the plurality of keywords related to compliance in the use of the predetermined drug. In some embodiments, the method includes determining a keyword of the plurality of keywords that identifies a diagnosis corresponding to the use of the predetermined drug. In some embodiments, the device obtains the list of web sites from a user specified configuration. In some embodiments, the device obtains the list of web sites from crawling a plurality of web sites.

In some embodiments, the method includes matching a portion of each web site having web site user generated discussions to the plurality of keywords. In some embodiments, the method includes filtering each web site to those web sites having discussions from patients focused on the predetermined drug. The device may rank each of the one or more online communities according to relevance of member generated discussions to the predetermined drug and the use of the predetermined drug. In some embodiments, the device identifies the one or more online communities having a relevance exceeding a predetermined threshold to solicit for survey participation. The device may rank each of the one or more online communities according to a side-effect from use of the predetermined drug.

In some aspects, the present solution is directed to a method for providing a survey based on online community discussions relevant to use of a predetermined drug. The method includes identifying, by a device, a plurality of patients who are users at one or more online communities and provided patient generated discussions about one or more sides effects from use of a predetermined drug, A survey is generated based on the plurality of patients discussions, generated online at the one or more online communities, on use of the predetermined drug. The device communicates a solicitation to the plurality of patients to participate in the survey and receives, responsive to the survey, data on the predetermined drug from patients participating in the survey.

In some embodiments, the method includes crawling a plurality of web sites to identify the one or more online communities comprising web site user generated discussions matching a plurality of keywords corresponding to the predetermined drug and use of the predetermined drug. In some embodiments, the method includes identifying from the discussions at the one or more online communities web site users who use the predetermined drug and provided relevant discussions on use of the predetermined drug. The method may include identifying the one or more online communities providing most relevant discussions about use of the predetermined drug.

In some embodiments, the survey may be designed to target collecting information on a patient's side-effect of use of the predetermined drug. The survey may be designed to target collecting information on a patient's compliance to prescribed use of the predetermined drug. The device may communicate the solicitation via a network to an electronic contact address of the patient. The solicitation may be posted via a network to the one or more online communities. In some embodiments, the device segments the data received from the survey into length of use of the predetermined drug, dosage of the predetermined drug and/or a side-effect from taking the predetermined drug. The data may be segmented by gender and/or age of the patient. The device may receive data from the survey identifying a quality of life index of the patient related to use of the predetermined drug.

In some aspects, the present solution is directed to a method for providing an assessment, such as a trial study or program, for a drug based on information from patients in online communities. The method includes identifying, by a device, patients from an online survey that indicated interest in participating in an assessment of a predetermined drug; From results from the online survey, a plurality of patients may be selected that have a predetermined diagnosis and a predetermined side-effect. Via the device, a protocol is generated or created for the assessment of the predetermined drug based on data collected from the online survey. Via the device, the protocol is communicated to the selected plurality of patients participating in the assessment. The device may receive from the selected plurality of patients information on compliance to the protocol and symptom relief from the predetermined side-effect.

In some embodiments, the method includes identifying the patients from the online survey that are likely to discontinue using the predetermined drug due to one or more side-effects. In some embodiments, the method includes identifying the patients from the online survey that exceed a predetermined threshold of risk to discontinue using the predetermined drug due to one or more side-effects. The method may also include communicating via a network a request to patients of the one or more online communities to participate in the assessment. The device may query a database having data collected via the online survey from the plurality of patients from a plurality of online communities.

In some embodiments, the plurality of patients are selected based on using the predetermined drug for at least a predetermined time period. The protocol is generated to prescribe a treatment plan for the predetermined drug. The device communicates via a network the protocol to a patient at an online community. The patient may submit via an online site information on symptom relief based on following the protocol. The data received the data received from the selected plurality of patents may be analyzed to determine results of the assessment.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIGS. 1D and 1E are block diagrams depicting an overview of an environment and system to design a product assessment and/or recruit participants;

FIG. 2A is a block diagram depicting an embodiment of a system for using online resources to design a product assessment and/or recruit participants;

FIG. 2B is a block diagram depicting another embodiment of a system for using online resources to design a product assessment and/or recruit participants;

FIG. 2C is a block diagram depicting another embodiment of a system for using online resources to design a product assessment and/or recruit participants;

FIG. 2D is a block diagram depicting another embodiment of a system for using online resources to to design a product assessment and/or recruit participants;

FIG. 2E is a block diagram depicting an embodiment of a system for using online resources to design a product assessment and/or recruit participants;

FIG. 2F is a block diagram depicting an embodiment of a system for using online resources to design a product assessment and/or recruit participants;

FIG. 3A is a flow diagram depicting an embodiment of a method for community identification and patient discovery; and

FIG. 3B is a flow diagram depicting an embodiment of a method for design, execution and communication of an assessment.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes an overview of embodiments of the present solution;
Section C describes embodiments of systems for using online resources to design, execute drug assessment trials, studies or programs; and
Section D describes embodiments of methods for online resources to design, execute drug assessment trials, studies or programs.

A. Computing and Network Environment

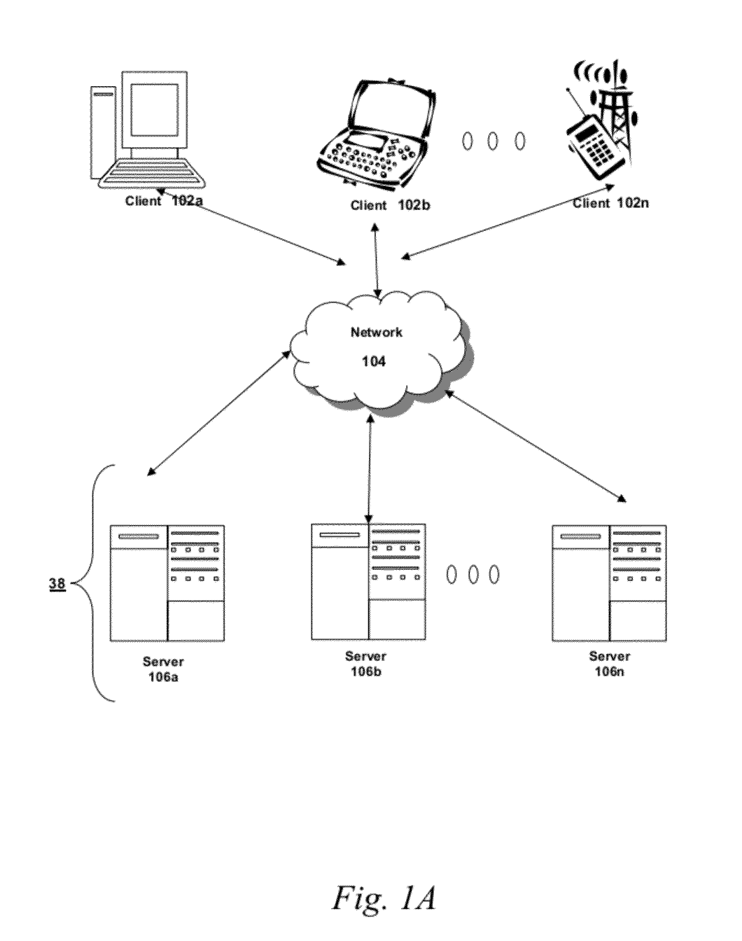

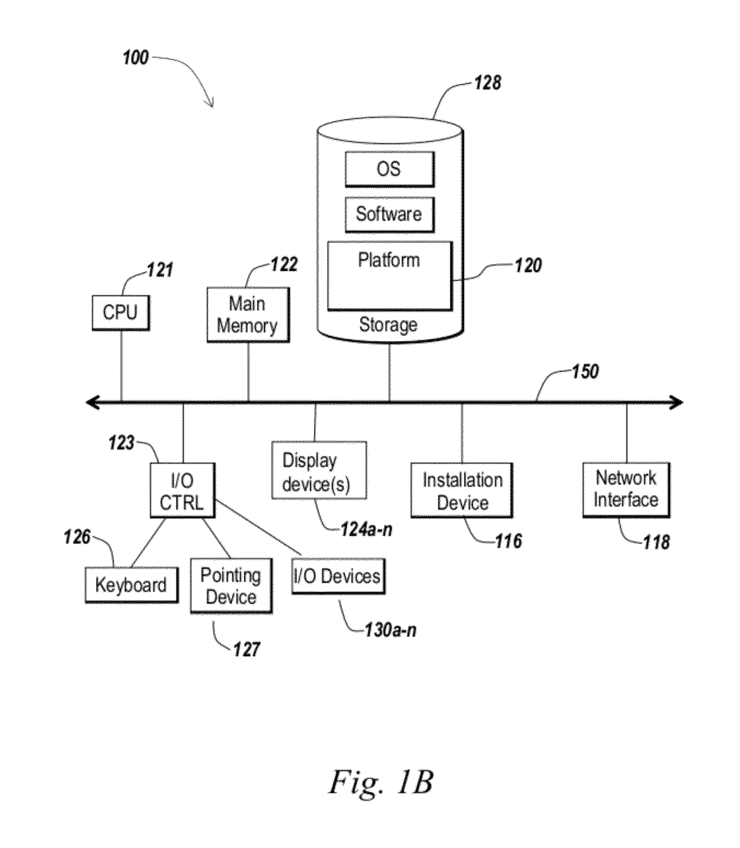

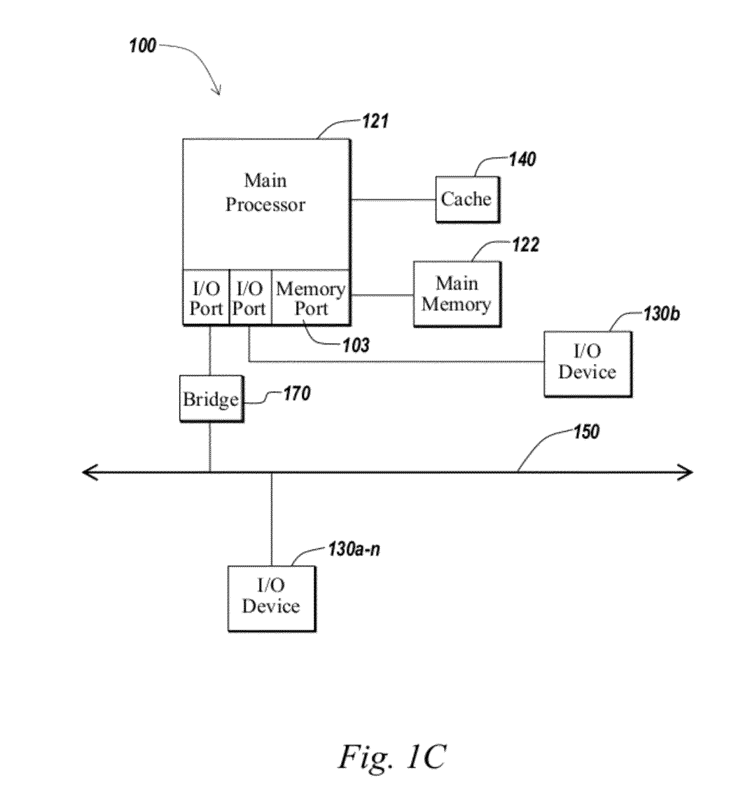

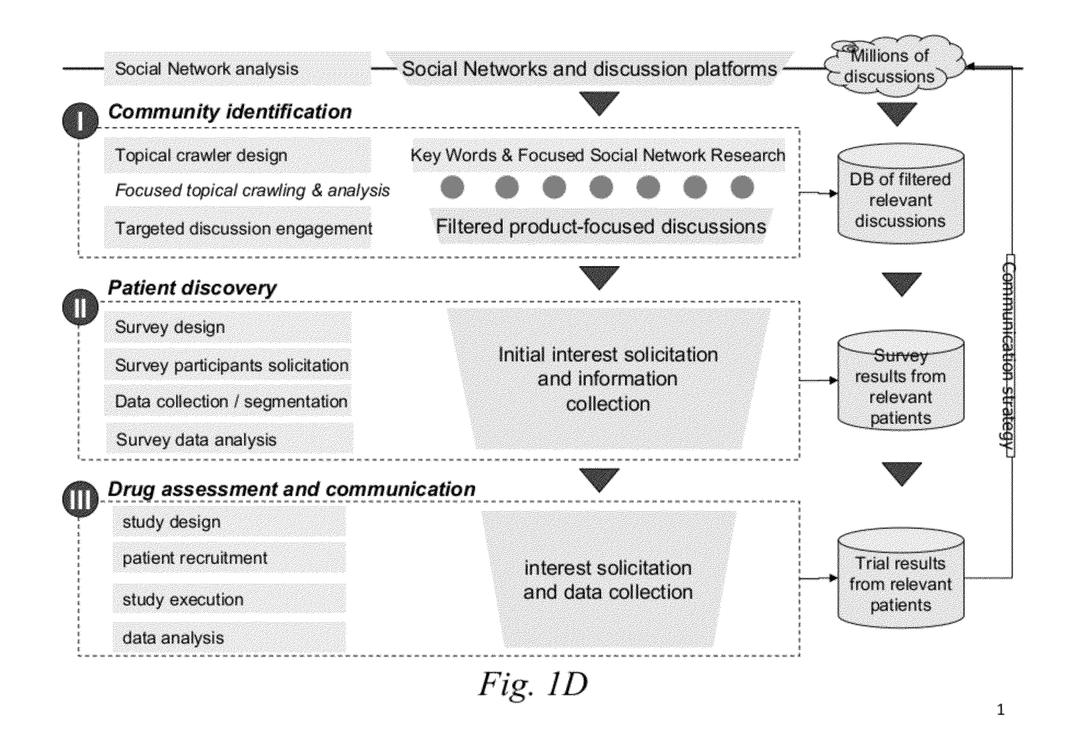

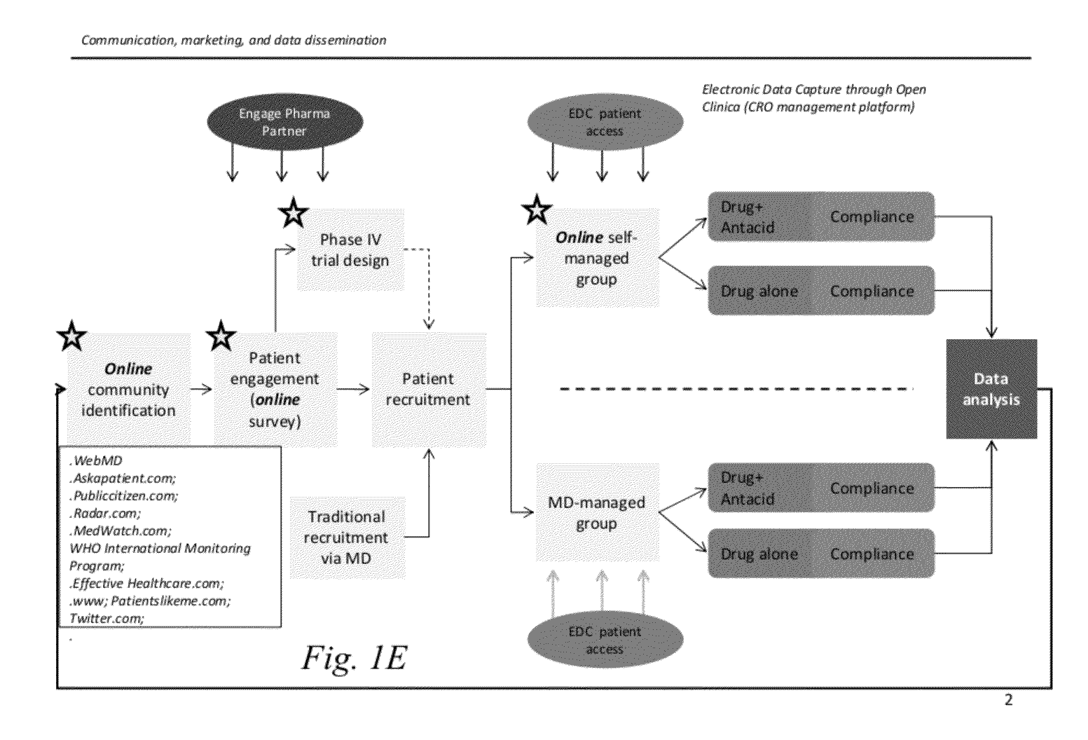

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 102 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes may be in the path between any two communicating servers.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-102n, a keyboard 126 and a pointing device 127, such as a mouse. The storage device 128 may include, without limitation, an operating system and software 120 performing any of the systems and methods described herein. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for performing any of the operations described herein. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95c1, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudimpression opportunity layer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the communications device 102 includes a combination of devices, such as a mobile phone combined with a digital audio player or portable media player. In one of these embodiments, the communications device 102 is a smartphone, for example, an iPhone manufactured by Apple Computer, or a Blackberry device, manufactured by Research In Motion Limited. In yet another embodiment, the communications device 102 is a laptop or desktop computer equipped with a web browser and a microphone and speaker system, such as a telephony headset. In these embodiments, the communications devices 102 are web-enabled and can receive and initiate phone calls. In other embodiments, the communications device 102 is a Motorola RAZR or Motorola ROKR line of combination digital audio players and mobile phones.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Using Online Social Networks for the Design, Execution, and Results Communications of Product Assessments

Individuals are increasingly turning to the Web for obtaining and/or sharing health information. The proliferation of health and/or medical related websites, blogs, and discussion boards provide avenues for individuals to proactively participate in their own well-being, e.g., generally educating themselves, looking for specific answers, sharing personal experiences, or warning and informing others with respect to certain health or medical issues. Such online resources may provide a wealth of information about patient concerns, patient profiles, and therapeutic effectiveness and benefit as reported by patients themselves.

The present solution is directed to using social networks and online communities for the design, execution and results communications for product assessments, including drug assessments, clinical trial studies, such as Phase IV studies. Referring to FIG. 1D, a diagram provide an overview of the present solution is depicted. In brief overview, in a first phase, referred to as community identification, of the present solution identification of online communities is performed via (i) topical crawler design, (ii) focused topical crawling and analysis and (iii) targeted discussion engagement, In a second phase, referred to as patient discovery, (i) online survey id defined, (ii) participants from the online communities are solicited for the survey, (iii) data is collected from the survey and segmented and (iv) the survey data is analyzed. In a third phase, referred to as a drug assessment and communication, (i) a clinical study is designed based on survey results, (ii) patients filtered from the surveys are recruited for the study, (iii) the study is executed, such as via online management of trial by patients and/or in the clinical setting under supervision (e.g., physician managed care) and (iv) analysis of the data from the trial is analyzed and trial results are communicated, such as via the online communicates or to the participants.

In further overview, the Internet and social network have a plurality of user generated discussions around patients, diseases (therapeutic areas) and drugs. For example, members of a web site may generate comments in a discussions forum of a web-site regarding the use, benefits and side-effects of a particular drug by the patients themselves. The present solutions provides for filtering relevant discussions around specific patients/drugs, or any type and form of products, including but not limited to drug, device, biologic, natural health product, over-the-counter product or any type and form of healthcare product (e.g.. tiger balm), and assessment of any type and form of disease, and assessment of any type and form of therapy and/or an assessment of a combination of disease, product and/or therapy.

With access to highly relevant communities the present solution obtains scaled yet specific patient data through targeted surveys. Results of these surveys are stored in a database to provide relevant patient information with regards to use, compliance and side-effects of a particular drug. This database of relevant patient information is leveraged to design clinical trials, such as Phase IV trials and recruit relevant patients. The trial or stuffy results may be effectively disseminated through highly relevant patient groups through their online communities.

During a first phase or an embodiment of the present solution, social networks and discussion platforms are analyzed to identify the online communities with the most or more relevant patient discusses regarding a predetermined or particular drug. Social networks and discussion platforms house millions of discussions, visited daily by an increasing percentage or number of patients. Patients are becoming more open about their personal information on personal networks (e.g. healthcare related information such as diagnosis, drug use, compliance, benefits and side-effects of a drug). As such, there are millions of discussions and knowledge sharing around health and wellness on the web in multitude of online communities and discussion boards. Sometimes these discussions and knowledge sharing of a particular drug, diagnosis or use of the drug is fragmented and distributed across a heterogeneous set of online communities and discussion board. Technology of the present solution allows for harnessing information on social network in an organized manners The present solution may implement crawling technologies to focus on specific topics and conversations: “who is saying what, where and when” with respect to patients and corresponding drug information. The results of crawling via the present solution provides an organization/company the ability to identify and join relevant consumer communities. During this phase, keywords are used to perform focused social network research across a multitude of discussions across a plurality of online communities to provide a database of filtered product-focused or relevant discussions.

During a second phase or an embodiment of the present solution, such organizations or companies can participate in relevant discussions. Organizations can use targeted surveys or patients may use self reporting via their voluntarily sharing of relevant information when invited to enter data into a particular webpage. Self-reporting and/or targeted surveys can be used to collect large amounts of highly relevant data about patients and drugs. From the online communities of the previous phase, relevant patients have been identified. Surveys can identify initial interested from such patients while collecting information on compliance, side effects and quality of life from such patients. Data can be analyzed to effectively design from the grounds up focused studies.

During a third phase or an embodiment of the present solutions, a clinical or trial study, such as Phase IV studies are designed based relevant information collected from focused online surveys. Clinical trials or phase IV studies are a step in medical research conducted to allow safety (or more specifically, information about adverse drug reactions and adverse effects of other treatments) and efficacy data to be collected for health interventions (e.g., drugs, diagnostics, devices, therapy protocols). Phase IV studies, often called Post Marketing Surveillance Trials, are conducted after a drug or device has been approved for consumer sale. Pharmaceutical companies have several objectives at this stage: (1) to compare a drug with other drugs already in the market; (2) to monitor a drug's long-term effectiveness and impact on a patient's quality of life; and (3) to determine the cost-effectiveness of a drug therapy relative to other traditional and new therapies. Phase IV studies can result in a drug or device being taken off the market or restrictions of use could be placed on the product depending on the findings in the study. With the present solution, patient recruitment is more efficient given the access to a pool of pre-filtered highly motivated patients from the community identification and survey phases of the present solution. Given the access to relevant patients, in some embodiments, studies may remain adequately powered despite the use of a lower number of patients

Referring now to FIG. 1E, a diagram providing another overview of a flow or method of the present solution is depicted. In brief overview, online community identification is performed to identify online communities with relevant discussions from patients of a drug under consideration for analysis or design of a survey or study. From the online community discussions, a survey is designed based on such discussion. Patients from the online community are identified for the survey and solicited for participation in the survey. Data is collected from the online survey. From the patient discovery phase, a phase IV trial study is designed. For example, a protocol is created based on survey results and collected data. From the filtered survey results, patients for the trial study are recruited. The protocol for the study may be communicated electronically to the patients participating in the study. The trial study is executed and managed via online self-managed group and/or a doctor managed group. Data from the trial study are collected and analyzed. The results of the trial study may be communicated to the online communities.

In some embodiments, the platform 200 of the present solution may provide a work flow engine, business rules and interface to facilitate, provide or execute any of the online community identification, patient discovery via online survey, trial study, patient recruitment and online self-managed group and data collection from doctor managed groups. The platform may comprise one or more modules, services, tasks, applications, programs, scripts or libraries to execute the functionality described herein corresponding to online community identification, patient discovery via online survey, trial study, patient recruitment and online self-managed group and data collection from doctor managed groups.

### C. Systems for the Design, Execution, and Results Communications of Product Assessments

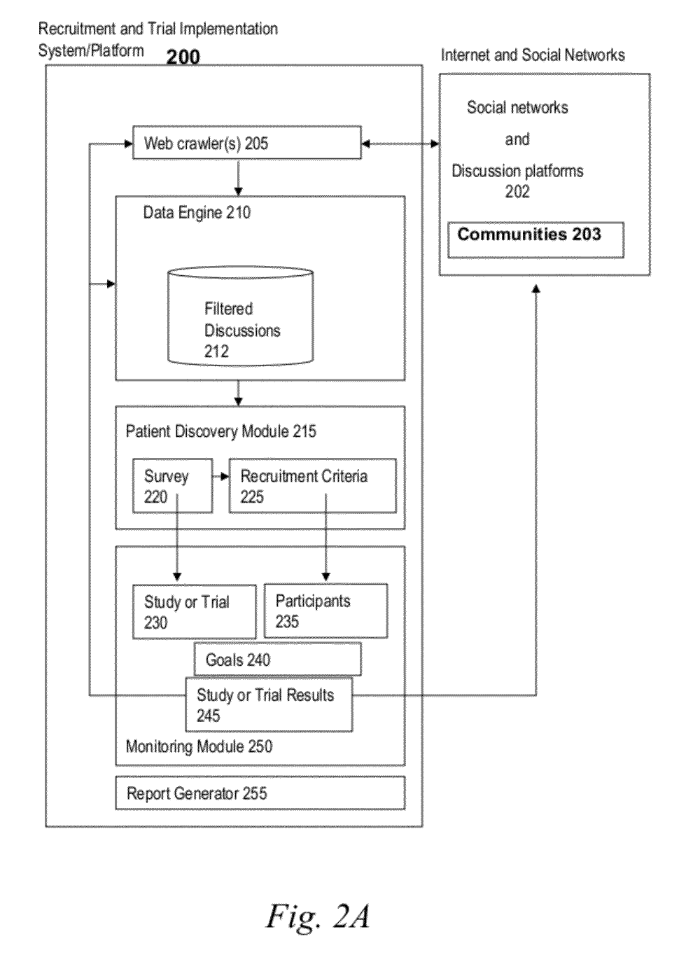

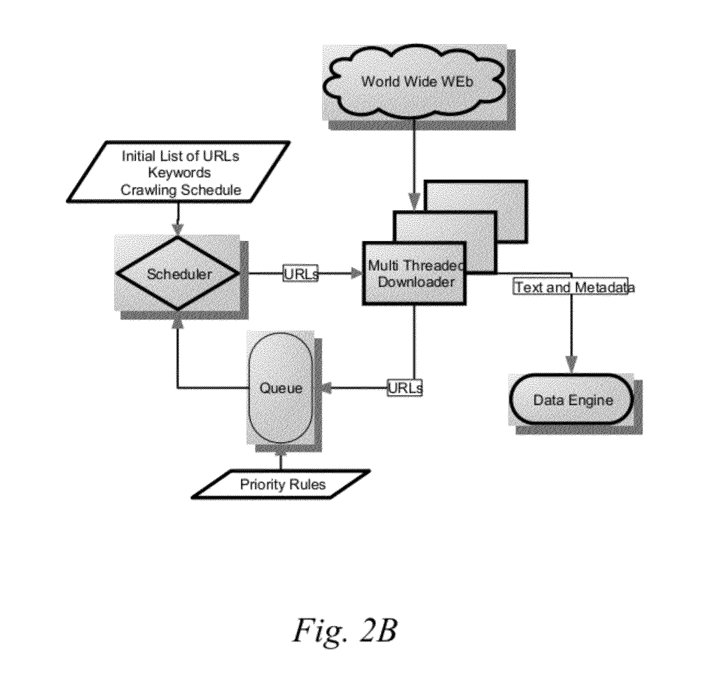

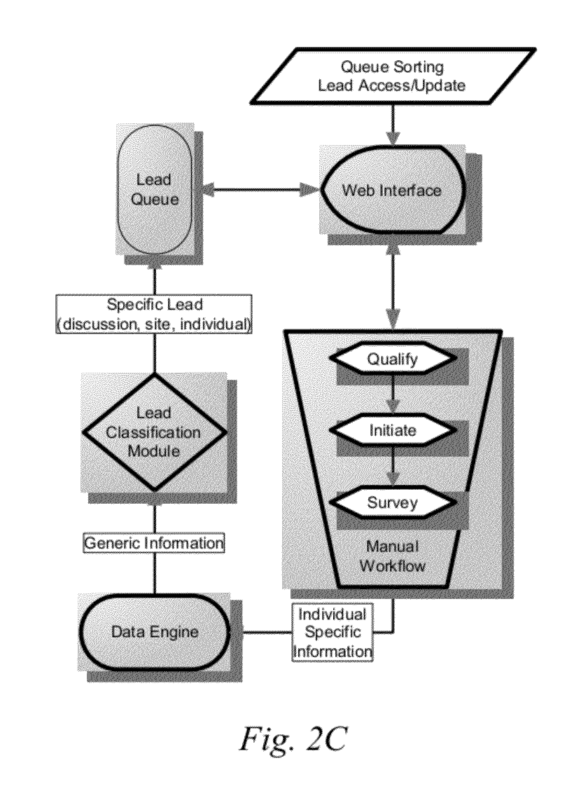

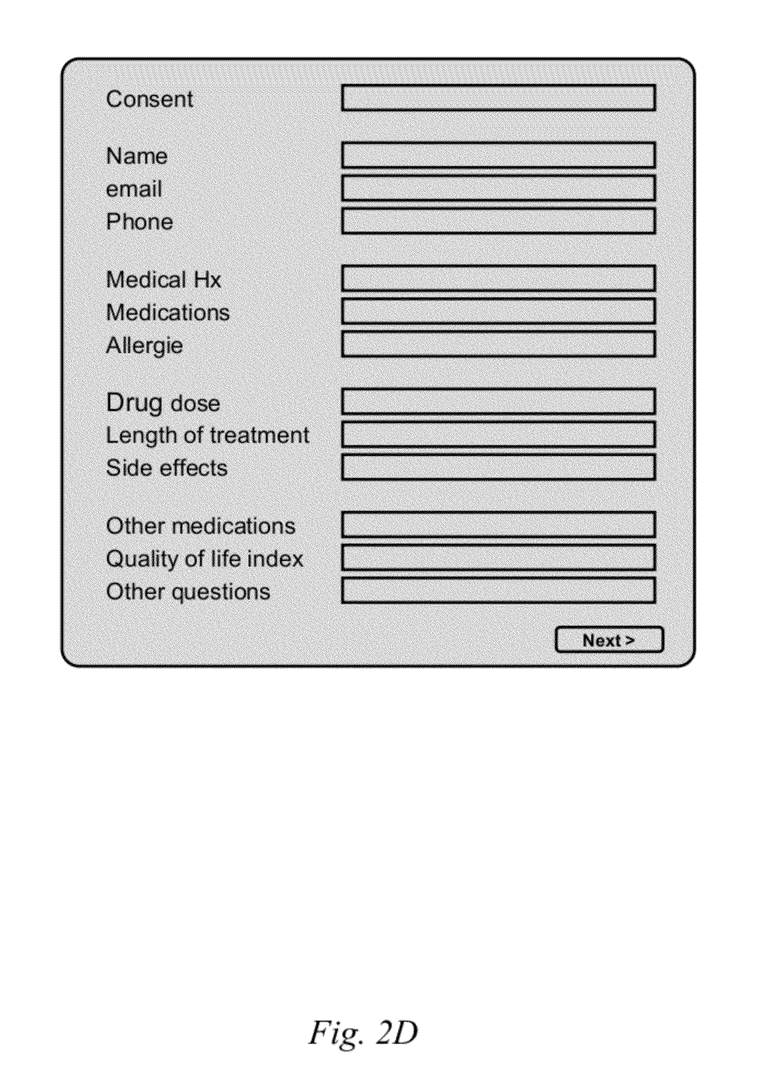

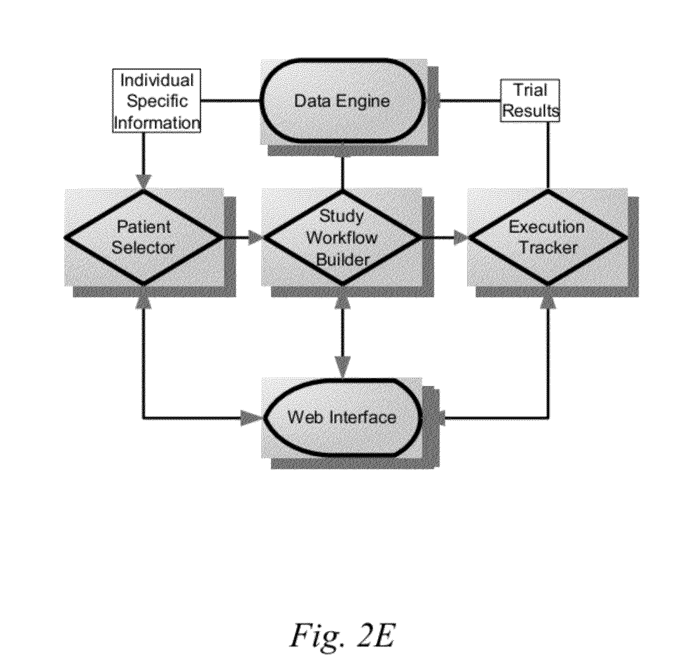

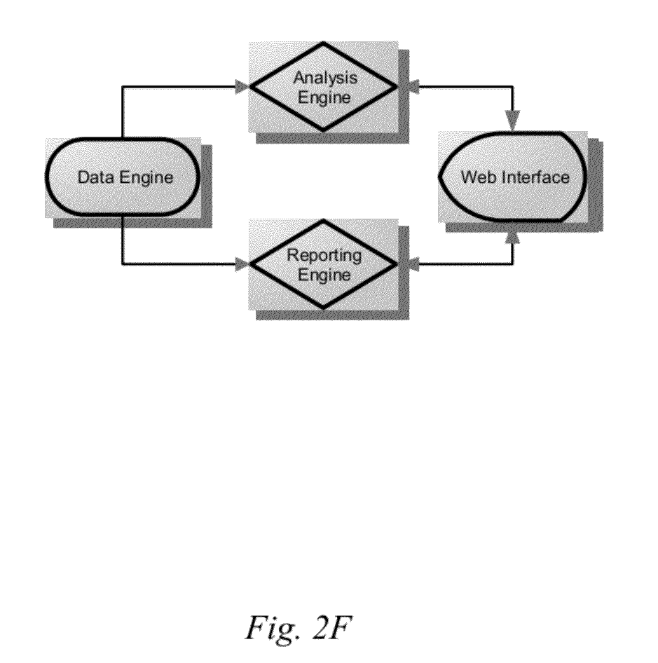

Referring to FIG. 2A, an embodiment of a system for using online resources for the design, execution and results communications of a product assessment is depicted. The product may include a drug, device, biologic, natural health product, over-the-counter product or any type and form of healthcare product (e.g.. tiger balm). The assessment may include the assessment of any type and form of disease. A disease may be any type and form of an impairment of health or a condition of abnormal functioning. A disease or medical condition is an abnormal condition of an organism that impairs bodily functions, associated with specific symptoms and signs. The disease may be caused by external factors, such as infectious disease, or it may be caused by internal dysfunctions, such as autoimmune diseases. The assessment may include the assessment of any type and form of therapy, which may include any type and forms of medical or health related care.. The assessment may include any combination of disease, product and/or therapy. The product assessment may include clinical trials and adherence/compliance programs of a product, disease and/or therapy.

In brief overview, the system includes one or more web crawlers for collecting data relating to one or more topics, a data engine for storing and processing the data, a patient discovery module for soliciting information and participants for the medical study, and a monitoring system for the study. In some embodiments, a clinical trial module incorporates features of the patient discovery module and the monitoring module 250. In some embodiments, part or all of such a system may be owned and operated by any entity or organization (e.g., pharmaceutical company, hospital). Components of the system may be networked as described above in connection with FIG. 1A. Certain functionality of the system may be provided by different servers or devices as described above in connection with FIG. 1A. Each component of the system may incorporate hardware features provided by embodiments of the computing device 100 described above in connection with FIGS. 1B and 1C. Part or all of such a system may be leased by an entity or organization. In certain embodiments, we may offer embodiments of the processes described herein as services to an entity or organization interested in tapping online resources design a clinical study, sponsor a clinical study, and/or recruit volunteers for a clinical study.

In some embodiments, online resources include online social networks and discussion platforms 202. Social networks may include any type and form of a website, or network of websites, established to allow end users to communicate directly with each other on topics of interest and/or mutual interest. Discussion platforms may include any type and form of a website, network of websites, or sections or portions of these web-sites that enable and provide for discussions between users on topic or topics of mutual interest. Social networks and discussion platforms may provide for user generated or user identified: topics, subject matter for discussions and/or discussion threads. Social networks and discussion platforms may store comments, questions, statements or other input generated by a user of the social network or discussion platform. Social networks and discussion platforms may organize and store these discussions in any type and form of structure. For example, some web-sites may organize the input from users into certain fields, headers or tables. Social networks and discussion platforms may organize and store these discussions in a free form manger with no or little structure.

These social networks and discussion platforms may include millions of discussions aggregated over some time period, such as a day, a week or year. Discussions and new data may be updated daily on these online resources. Some individuals, such as patients, may be more open and candid about their personal information (e.g., medical history or healthcare information) on certain social networks or discussion platforms. The present methods and systems may, over a number of phases, recruit suitable candidates and conduct a medical trial. Suitable candidates may include individuals currently treated for a disclosed condition or healthy individuals concerned about their health in general. In the latter case, for example, an individual may be blogging for the sake of information, or they may be predisposed genetically or have a high risk of developing a condition at some point in their life. Both healthy and diseased candidates may be recruited and matched with suitable clinical studies. One of the initial phases may involve community identification. Community 203 identification may include identification of websites, social networks and/or discussion platforms in connection with a target audience and/or topic.

In one embodiment, the platform includes one or more web crawlers 205 for finding websites or data over the Internet and/or other networks (e.g., subscription/membership networks). A web crawler may include hardware or a combination or hardware and software. The web crawler may include any module, script, program, agent, state machine, component or set of executable instructions executing on one or more machines or servers. The web crawler may incorporate program code based on open source software, commercially available software, or a combination of both. The program code may be designed for fast execution on hardware. The program code may be architected for flexible adaptation to new configurations and/or incorporating of new functionality. The web crawler may use screen scraping, optical character recognition (OCR) or any combination of screen scraping and optical character recognition (OCR) to find or identify keywords in content of a site. The web crawler may use any type and form of search engine.

Each web crawler may be configured and/or adapted to collect any suitable information for storage or further analysis. Each web crawler may be configured to focus on collecting or tracking specific topics and conversations, e.g., who is saying what, where and when. A topic may be described and/or identified by any combination of one or more networks, online communities, websites, web links (e.g., URLs), products, medical conditions and key words. The web crawlers may be configured with keywords identifying or representing a topic. In some embodiments, a web crawler may target online discussions focusing or related to a product, such as a pharmaceutical drug or medical device. The web crawler may interface with network applications for collecting topical data and other information (e.g., user profile, user traffic, etc). Network applications may include applications provided, configured, or built for specific websites, social networks and/or discussion platforms, such as Twitter, Facebook, LinkedIn and WebMD. Each network application may perform some of the functions of a web crawler with respect to a particular online resource. For example and in one embodiment, a network application may provide a digest or RSS feed of information extracted from an online resource. In some embodiments, a web crawler may gain access to a non-public network (e.g., Facebook social media network) or discussion platform through a network application.

In some embodiments, a web crawler may be initially configured with one or more of: a list of uniform resource locators (URLs), a set of keywords, and a crawling schedule. The web crawler may be activated based on the schedule. The web crawler may systematically or randomly access each of the URLs to locate data or web pages matching the keywords. The web crawler may include a downloader that can process each web page sequentially. The web crawler may include a downloader that can process a plurality of web pages concurrently. In one embodiment, the web crawler includes a multi-threaded downloader. The downloader may process the web pages and generate or collect text and/or metadata related to one or more topics. The downloader may generate a list of URLs for further crawling or investigation. In some embodiments, the downloader extracts URLs from web content. In certain embodiments, the downloader automatically generates URLs for processing. The generated list of URLs may be queued (e.g., in a buffer of the web crawler) for crawling according the crawling schedule.

The web crawler may store the text and/or metadata (hereafter sometimes generally referred to as “data”) in a database 210/212 for further analysis. The system may maintain the database in one or more storage devices, e.g., over a storage area network (SAN). In some embodiments, the web crawler may provide the data to a data engine 210 or topical analysis module (hereafter sometimes generally referred to as “data engine”) for analysis. The data engine may include or incorporate at least part of the storage device(s) for storing the data.

The system may include a data engine and/or analysis interface for processing and/or analyzing the data. An analysis interface may provide customer resource management (CRM) type features or systems to monitor, track and/or update progress in one or more leads. The analysis interface may coordinate or manage the process of generating surveys, e.g., from raw crawler data. In some embodiments, a user may design a survey via the analysis interface. An analysis interface may include any module, script, program, agent, state machine, component or set of executable instructions executing on one or more machines or servers. The analysis interface may incorporate program code based on open source software, commercially available software, or a combination of both.

The analysis interface may include any type or form of interface to process data to, from and/or between components (e.g., data engine) of the system. The analysis interface may include an interface, such as a web interface, to leads provided by the web crawlers or any other sources. These leads may include discussion, community, topical, user and/or site specific leads. The leads may be processed or provided as a queue. For example and in one embodiment, the web crawler or other lead source may sort and/or update a plurality of leads. The data engine may provide the leads to the analysis interface via a web interface of the analysis interface. The data engine or lead source may provide access to the leads via a web interface. In some embodiments, the analysis interface queues the provided leads. The analysis interface may include an analysis engine. The analysis engine may receive any type or form of data from the system for analysis. For example and in one embodiment, the analysis engine may collect information from a survey or trial and perform statistical analysis. The analysis interface may receive generic information (e.g., from a data engine) and process this information into one or more leads. For example and in one embodiment, the analysis interface may classify or associate information into leads, e.g., via a lead classification module.

In some embodiments, one or more users may process leads or data collected from online resources via the analysis interface. A user may qualify a lead or collected data, such as matching contents to an identified topic. A user may initiate discussions via the lead or online resource, e.g., to obtain more information or to stir interest. A user may create and/or offer a survey via the lead or online resource. Some or more of these steps may be referred to as part of a manual workflow. A user may perform one or more of these steps via a web interface of the analysis interface. This workflow may yield individual-specific information. The workflow may send the information for processing in the data engine. The processed information may be further developed into leads (e.g., via a lead classification module). The analysis interface may track the progress or formation of a lead according to any of the steps described above.

In some embodiments, a data engine may consolidate multiple databases and/or collected data. These databases and/or data may come from one or more web crawlers, surveys, interviews (e.g., via an online discussion), or any other means. The data engine may process, organize, filter, and/or extract data relevant to a particular topic. The data engine may be configured and/or adapted to filter away certain information, e.g., intelligently, via filtering rules or policies. For example, some of the filtering rules may identify machine-generated information and/or sponsored-messages for filtering. The data engine may identify and join relevant consumer communities, for example, based on a specific topic and/or related topics. The data engine may include hardware or a combination or hardware and software. The data engine may include any module, script, program, agent, state machine, component or set of executable instructions executing on one or more machines or servers. In one embodiment, the data engine provides or maintains a filtered database 212 comprising relevant discussions targeted at a topic (e.g., pharmaceutical drug). In another embodiment, the data engine generates information in generic form for classification into one or more leads. The generic form may include data organized in a standard or predefined way.

In some embodiments, a data engine includes one or more of: (i) data storage, (ii) one or more databases, (iii) data access rules, and (iv) data interface procedures. For example and in one embodiment, data access rules may determine if a user or client may have the access rights to access trial or survey results at any particular time. Data interface procedures may dictate or require that web crawlers or other data sources provide data in a certain format. Data interface procedures may dictate or require that requests for report generation are handled at specific times and/or via specific interfaces. The data engine may be designed and configured to be scalable, fast and/or secure. The data engine may be designed and built for flexibility, e.g., flexible reconfiguration and extension of capabilities.

In some embodiments, the system processes a database generated from the community identification phase. The system may process this database during a patient discovery phase. The patient discovery phase may include, but is not limited to, one or more of the following: (i) designing a patient survey, (ii) soliciting participants for the survey, (iii) collecting and/or segmenting survey data, and (iv) analyzing survey data. The system may include a patient discovery module 215 for performing or facilitating one or more of these functions. In some embodiments, the patient discovery module incorporates features from embodiments of the analysis interface discussion above. The patient discovery module may include hardware or a combination or hardware and software. The patient discovery module may include any module, script, program, agent, state machine, component or set of executable instructions executing on one or more machines or servers. In some embodiments, the data engine is the processing and/or storage core of the system.

One or more portions of the patient discovery process may be performed by a patient discovery module and/or one or more users or specialists. For example and in one embodiment, the patient discovery module may process the database to design or generate a survey. In another embodiment, one or more users or specialists analyzes the database (e.g., via the patient discovery module) to design or generate the survey. Some portions of the survey may be automatically generated. Other portions of the survey may be designed by the one or more users or specialists. In some embodiments, the surveys are provided by an interested entity (e.g., a pharmaceutical company interested in conducting a drug-related trial). The system may identify to the entity the social networks or discussion platforms that are hosting relevant discussions. The entity may participate in any of the identified discussions, e.g., to test the interest of discussion members or to obtain information from these members.

During the patient discovery phase, the system may solicit one or more individuals (e.g., on behalf of the interested entity) for interest in participating in a survey. In some embodiments, the entity may identify potential survey participants to the system. In other embodiments, the system may identify potential survey participants via the discussions, profiles and other information collected by the web crawlers. The system may collect information provided by individuals during the solicitation, via the survey, via self-reporting via an interface to the platform or otherwise. An interested entity may provide targeted surveys to initiate specific conversations or discussions with potential survey participants. An interested entity may provide an interface, such as a web page or landing page, on which patients can self-report information that may otherwise be collected by a survey. Self-reporting and/or a targeted survey can be used to collect large amounts of highly relevant data about survey participants and/or any medical drugs, device or services they are using. The survey may be designed to perform one or more of: (i) collect additional information to supplement the information collected by the web crawlers, (ii) assess the suitability of an individual for participating in a medical trial, (iii) assess and/or increase a participant's interest in participating in the medical trial, and (iv) collect data for designing appropriate medical studies. The solicitation and/or surveys may be sent via known online resources or channels accessed by targeted individuals. For example and in one embodiment, a survey may be addressed or offered to a user of a social network or discussion board through the social network or discussion board itself.

The system may design a study based in part on survey responses and/or self-reporting from participants. The system may initiate a study based in part on the projected participation rate in the study. The system may include a web interface or other system that collects survey results for designing a study or trial. The system may include a concept (e.g., high-level concept) for a study, e.g., prior to incorporating survey results. The system may identify or generate this concept based on data collected from online discussions or other sources (e.g., pharmaceutical company, medical professional, government agency, other studies, patient feedback, etc). The system may refine a concept or design for a study using results from one or more surveys. One or more related or independent surveys may be designed and conducted in parallel or in sequence to collect information (e.g., incrementally) for designing or refining a study.

The system may identify certain attributes or characteristics related to a topic (e.g., medical/health product or service) from the survey results of relevant individuals, e.g., issues or complaints about a product, length of use of the product, patient demographic, patient motivation, etc. The survey may be designed to identify certain attributes or characteristics related to a topic. The survey may be used to rank issues (e.g., by importance, urgency and/or interest) pertaining to a topic in designing a study. Based on the attributes or characteristics, the system may design a study to address or research a particular aspect of the topic. The survey may be designed to identify parameters for a study or trial, e.g., acceptable or appropriate length of a trial, number of participants, compensation, accessibility of participants to required components of a study, required compliance level, related risks, avoidance of legal and/or FDA-related issues, etc.

The system may design a study workflow that can be self-managed by a participant. The system may design a study workflow that is managed by a medical practitioner. The system may design a study workflow that has both managed and self-managed elements. In some embodiments, the system may design parallel studies, e.g., one managed by a medical practitioner and another self-managed by a participant. The system may design a study workflow that can be executed online, through a medical network, through an application program, via mail or email, through an automated or managed phone system, as well as any other embodiments incorporating any of these and/or other aspects. The system may identify one or more goals 240 of a study before architecting other aspects of the study.

The system may design a medical/clinical study using a study workflow builder of the system. The system may design such a study in an assessment and communication phase. For example and in one embodiment, the system may design a study or trial to address or research a particular aspect of a drug. In some embodiments, the system may include intelligence (e.g., algorithms, artificial intelligence) to design a study or trial (hereafter sometimes generally referred to interchangeably as a “study” or “trial”). In other embodiments, specialists or professionals may design the study or provide inputs to guide the system in designing the study. In some embodiments, a study or trial of a drug, device or service may be designed to (i) test and document its effectiveness, (ii) increase compliance in its use or offer insights on how compliance can be increased, (iii) address issues to mitigate loss of patients/customers for the drug, device or service, and (iv) improve branding of drug, device or service to mitigate market share loss.

In some embodiments, the system may segment, categorize, partition, group or otherwise organize the survey results based on the content of responses. Samples derived from survey participants may provide scaled representation of a larger community. Relevant individuals for a study may be identified using the survey. When obtaining personal and/or health information from an individual (e.g., volunteer or patient), the system may request for personal consent, e.g., in view of data or privacy protection. This and other requirements may be in compliance with laws, directives and statutes governing the use, protection, transmission, sharing and/or storage of information in various contexts (e.g., educational, research, commercial). Examples of such laws, directives and statutes include the Health Insurance Portability and Accountability Act of 1996 (HIPAA), Personal Information Protection and Electronic Documents Act (PIPEDA) and European Union Directive on Data Privacy (EU Directive). The system may be configured and updated to provide online and offline support of any of these requirements. In some embodiments, system databases may be encrypted and system services may be configured with access control systems.

One or more surveys may pre-filter survey participants and provide a pool of relevant, interested and/or motivated patients for the study. Patients may be identified as relevant for recruitment based on a set of inclusion criteria 225, e.g., diagnosed and treated for osteoporosis, having gastrointestinal (GI) side-effects, and having interest in participating in a trial. Patients may be identified as not relevant for recruitment based on a set of exclusion criteria, e.g., high risk for heart attacks. The recruitment solicitation may occur via any known online resources or channels accessed by the targeted patients (e.g., discussion boards, email address, social network such as a Facebook account). In some embodiments, if a patient is linked to a medical practitioner, the patient may be recruited via the medical practitioner to participate in the study. Suitable patients may also be identified and recruited by a medical practitioner in a traditional recruitment method. The study may be managed by the medical practitioner or other medical practitioners.

Recruited patients (via online recruitment through the system, or via a medical practitioner, traditional or otherwise) may be provided the option to join a online self-managed group or a medical practitioner-managed group for the study. In one embodiment, online recruited patients are assigned to the online self-managed group while traditionally-recruited patients (via medical practitioners) are assigned to the medical practitioner-managed group. The study for one or both groups may interface with a clinical research organization (CRO) management platform such as openClinica (e.g., Phase Forward, Medidata Solutions, Oracle Clinical among others). The CRO management platform may perform electronic data capture (EDC) and/or other data extraction from schedules and records maintained for each study. For example, a patient in the online self-managed group may follow instructions for the study and update observations, progress, milestones, symptoms, etc, related to the study (e.g., use of a drug in a prescribed way). The CRO management platform may download or obtain updates at scheduled times or intervals. The system, such as via the CRO management platform, may track patient data and provide feedback or other instructions so that a patient can maintain compliance within the study.

Each group (e.g., self-managed group) may be further divided into subgroups for comparative studies. For example and in one embodiment, one group may study the effects of a single-drug prescription. Another group may study the effects of the prescription modified by a second prescribed drug or agent. Results from compliant patients from each subgroup of the study may be analyzed independently and/or compared. In some embodiments, the analyzed results may be used to modify or refine one or more of phases of the system (e.g., online community identification, patient discovery). In addition, each study or trial 230 may be designed with one or more goals or endpoints in minds, e.g., relief from medical symptoms or side-effects, usage compliance and demonstrated efficacy under compliant use, and self-managed resolution of medical issue. Metrics for each of the goals or endpoints may be determined and future or related trials modified accordingly to achieve better metrics.

In some embodiments, the system includes a clinical trial module. A clinical trial module may be designed or built to perform one or more of the following: (i) design a clinical study, (ii) recruit patients for the study, (iii) execute the study, and (iv) refine or modify the study based on results from the study. The clinical trial module may include any module, script, program, agent, state machine, component or set of executable instructions executing on one or more machines or servers. The clinical trial module may incorporate program code based on open source software, commercially available software, or a combination of both. The clinical trial module may include a web-based interface. The clinical trial module may include a patient selector module for identifying patients for a study. The clinical trial module may receive data (e.g., from the data engine) for use in identifying patients for a study. This data can include individual-specific information and which may be compared against criteria for selecting patient for a study.

A study workflow builder of the clinical trial module may receive information about the selected patients from the patient selector module. The study workflow builder may generate, design, configure, build and/or develop a study or a study workflow. Any aspect of a study may be created or modified with input from a professional, specialist, and/or government agency. The study or a study workflow may include one or more of: a schedule, instructions for the patient, milestones, and procedures for updating progress. The study workflow builder may provide study-related information for configuring a web interface for use by a patient. For example, the web interface may be configured for conveying instructions, receiving or updating progress, providing consultation to a patient, etc. For example, the study workflow builder may provide a Case Report Form (CRF) in electronic or paper form to collect data from participants or associated medical practitioners. In another embodiment, the study workflow builder may provide a patient diary (e.g., an electronic diary) to document progress in a clinical study. The study workflow builder may provide the construction of the study to the data engine and/or an execution tracker.

The clinical trial module may provide an execution tracker for monitoring or tracking the progress of the study. The execution tracker may monitor patient updates or questions entered via the web interface. The execution tracker may prompt the patient for updates or information regarding the study. The execution tracker may track milestones and/or any results from the study. The execution tracker may send the results of the trial or study t the data engine for analysis. In some embodiments, the data engine may use some of the study results to update the patient selection process, survey or study design and/or online resource data collection process.

In some embodiments, the system includes a report generator 255. The report generator may be built or configured to generator static and/or dynamic reports. These reports may include any one or more of the following: (i) amount of web crawler output per specific period of time, (ii) number of active leads for a specific study, (iii) number of active clinical trials, (iv) number and details of trial participants for each trial, (v) progress report for each participant, and (vi) results for a trial. These reports may be generated according to a schedule or on-demand. The report generator may operate with the data engine and/or analysis interface to organize or process data for generation of a report. In some embodiments, the analysis interface provides statistical analysis functions for studies and trials, and provides analysis results to the reporting engine. The report generator may interface with a web interface for displaying a report. The report generator may interface with a web interface for formatting data received from the analysis interface and/or data engine for display to a user. The web interface may provide the means for a user to request the report generator for a report. The report generator may provide a report via the web interface or via any media and format, e.g., email, PDF document, HTML, printed copies, etc. In some embodiments, the report generator is referred to as a reporting engine.

In some embodiments, results from a study may be shared with one or more online resources (e.g., the same online resources from which leads were derived). These results may be introduced into social networks and discussion platforms related to the identified topics. These results may benefit other individuals interested in or related to the identified topics (e.g., issues with drug use or side-effects). These results may improve branding or provide favorable reviews for products or services involved in the trial or study. The results may increase patient awareness or education in the identified topics. The results may increase interest in the products or services involved in the trial or study. The results may increase interest in individuals to participate in related surveys and/or studies. The results may attract or spark feedback regarding the products or services involved in the trial or study. The results may initiate additional discussions or feedback that may help refine the existing study or help formulate new or related studies.

Referring to FIG. 2B, an embodiment of a web crawler 205 to perform community identification is depicted. In brief overview, the web crawler may include a scheduler that obtains a list of URLs, keywords and a crawling schedule. Responsive to the scheduler, the web crawler may launch a multi-threaded or multi-processor, or multi-task downloader to download content from each of the URLs via a network 104, such as the world wide web. The web crawler may queue each of the URLs in a queue for crawling. The list of URLs in the crawling queue may be prioritized via one or more priority rules. From the downloaded content, the web crawler may identify, extract and store text and metadata from each of the URLs to the data engine. For example, the web crawler may identify, extract and store text and metadata from discussions at each of the URLs.

Referring to FIG. 2C, an embodiment of patient discovery module is depicted. The patient discovery module may include, interface to or communicate with a lead classification module. The lead classification module may obtain, receive or otherwise process data via the data engine, such as the text and metadata stored in the database via the web crawler. The lead classification module may include any type and form of executable instructions for processing the stored discussions information from web crawling to identify specific lead information, which may include but is not limited to specific discussion, URL/site and identification of individual/user/patient. The specific leads may be stored in a lead queue. In some embodiments, the lead queue is arranged or enumerated by a ranking, such as ranking of relevancy, date of discussion, age of patient, gender of patient, side-effect, diagnosis, dosage, drug, etc.

A web interface may be used for managing the lead queue and for qualifying leads from the lead queue. The web interface may be designed and constructed with interface elements arranged and provided for performing any of the functions or operations described herein. A user may access and review the lead queue to qualify the leads in any manner including based on relevancy, date of discussion, age of patient, gender of patient, side-effect, diagnosis, dosage, drug, etc. The web interface may be used to join any identified online communities to engage in or join discussions with leads or patients. The feedback, comments or results of such discussions may be used to qualify or further qualify a lead. The web interface may be used to solicit whether or not a lead or patient may be interested in participating in a survey.

The web interface may be used to design, generate, initiate and/or distribute a survey to one or more leads or patients, such as the survey described in connection with FIG. 2D. The web interface may include any templates, design tools or design canvas for creating, customizing or otherwise providing a survey. The web interface may include functionality, operations or logic to communicate the survey electronically via one or more networks to one or more users, such as leads at an online community. The web interface may post or publish the survey to a social network. The web interface may distribute the survey via email, SMS, IM, texting, twitter and the like. The web interface may distribute, post or publish a link or URL to the survey, such as posting or providing a link to a discussion platform or social network having patients identified as leads. The web interface may include a landing page or web page on which users or patients can self-report on the information identified or sought by the survey.

Referring now to FIG. 2D, an example of a survey is depicted. The survey may include input for any type and form of contact information, such as name, email and phone number. The survey may include any type and form of consent, such as consent via signature or acknowledgement, such as via selection of user interface element. The survey may include input for description or identification of medical history, medications and allergies of a patient. The survey may include identification of drug, drug dosage, length of treatment and/or side-effects. The survey may include input to identify other medications. The survey may include input of a quality of life index which identified from the patient's and/or a health/medical perspective their current quality of life. The quality of life index may be selectable value in a predetermined range or a selection of a predetermined set of descriptions. The survey may include input for the survey taker to ask any questions or provide comments or other information. In some embodiments, instead of a survey, the platform includes a portal or landing page in which patients can identify themselves and submit information about their use of a product. The portal or landing page may provide an interface for the user or patient to provide the same information as the survey. In some embodiments, the portal or landing page includes the survey.

Referring to FIG. 2E, an embodiment of the platform for designing and executing a clinical trial is depicted. A web interface may provide access to and/or use the study workflow builder, patient selector and/or execution tracker. The patient selector module may include any type and form of executable instructions to allow a user to review and select one or more patients to consider, solicit or request to participate in a clinical trial. Patient specific information for the patient may be provided by the data engine. The patient selector may present, show or provide any of the patient's attributes, characteristics or information from web crawling discussions and/or survey data collection. The study workflow builder may be used to design, create, generate or otherwise specify a study, a product adherence program or product compliance program. The study workflow builder may specify any requirements, data collection, patient input, patient criteria, dosage, treatment plans, treatment duration, etc. The execution tracker may monitor and track the progress of the study or program The execution tracker may send electronic follow up correspondence to request or solicit input, feedback or comments from the participants. The execution tracker may send electronic reminders to the participants to follow the protocol of the program or study. The execution tracker may send surveys, links to a web interface or other electronic means to the participants provide input, status, comments and/or feedback of the participation in the study or program. The results of the study or program may be stored in a data engine for communications to the participants and/or company sponsoring, monitoring and/or executing the study or the program.

Referring to FIG. 2F, an embodiment of an analysis engine and reporting engine of the platform for providing reports of data collected and analyzed from the web crawling, survey data collection and results of execution of the study or program. A web interface may provide access and use of the functionality and operations of the analysis engine and reporting engine. The analysis engine and reporting engine may be used to find new information, clusters or information from the data from filtered discussions, data collection from surveys, and data collected from execution and monitoring of a study or program and data from results of the study or program. The analysis engine may use any type and form of analysis or modeling to identify relationships between data, such as relationships between discussion data, survey data and study/program data. The analysis may store analyzed data to the data engine. The reporting engine may provide a tool for designing, querying and/or processing data from the data engine.

### D. Methods and Example of the Design, Execution, and Results Communications of Product Assessments

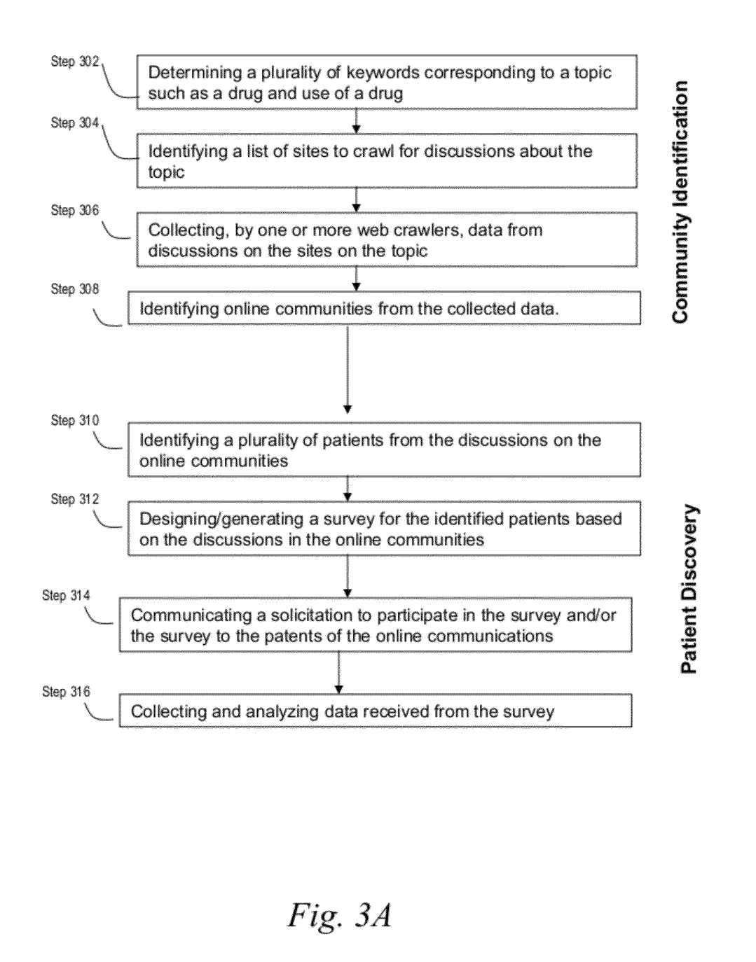

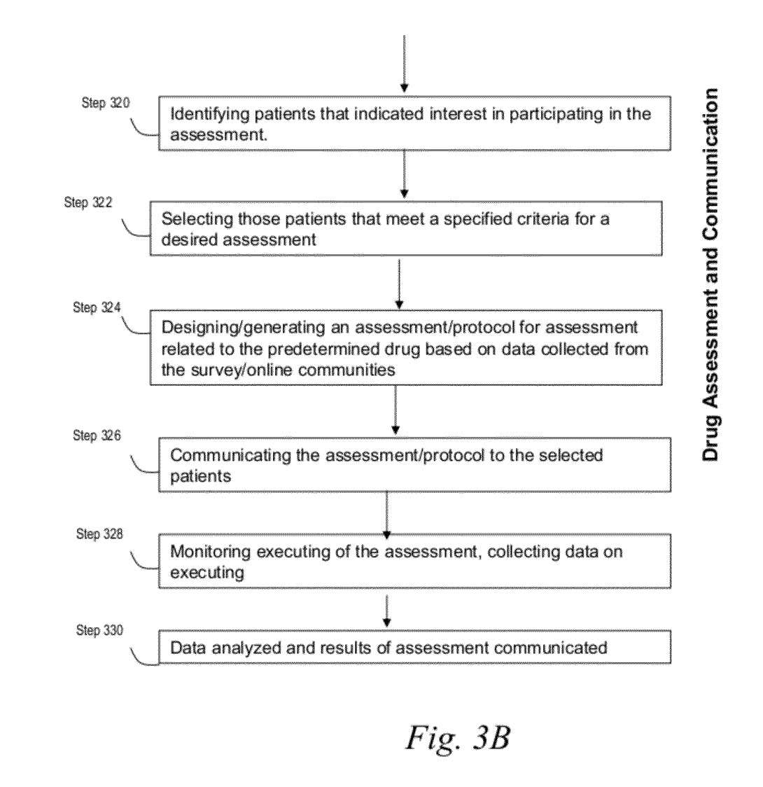

Referring to FIGS. 3A and 3B, embodiments of steps of methods for using online resources for the design, execution and result communications of embodiments of a product assessment comprising a drug assessment, including clinical trials and adherence/compliance programs is depicted. FIG. 3A depicts embodiments of steps of a method for community identification and patient discovery while FIG. 3B depicts embodiments of steps of a method for design, execution and results communication of an assessment. Although the methods of FIGS. 3A and 3B may be generally described in connection with a drug assessment, these methods may be applied to and applicable to any type and form of product assessment, including but not limited to drug, device, biologic, natural health product, over-the-counter product or any type and form of healthcare product (e.g.. tiger balm), and assessment of any type and form of disease, and assessment of any type and form of therapy and/or an assessment of a combination of disease, product and/or therapy.

Referring now to FIG. 3A, embodiments of methods of community identification and patient discovery will be discussed. In brief overview of community identification, at step 302, a plurality of keywords are determined that correspond to a predetermined topic, such as a predetermined drug and use of the predetermined drug. At step 304, a list of sites is identified to crawl for finding discussions related to the predetermined topic. At step 306, the web crawling collects data from the sites matching the predetermined topic. At step 308, online communities having relevant discussions on the predetermined topic are identified from the collected data.

In further details, at step 302, a plurality of keywords are determined, designed or constructed corresponding to a predetermined topic. The predetermined topic may comprise discussions on a predetermined drug, including discussions on use, compliance, side-effects, benefits and quality of life related to the drug and patients using the drug. In some embodiments, the keywords may correspond or identify any one or more names for a drug. In some embodiments, the keywords may correspond or identify any one or more diagnosis for using the drug. In some embodiments, the keywords may correspond or identify any one or more side-effects for using the drug. In some embodiments, the keywords may correspond or identify any one or more treatment lengths, plans and/or dosages for using the drug. In some embodiments, the keywords may correspond or identify any one or more benefits for using the drug. In some embodiments, the keywords may correspond or identify any one or more complaints, complications or quality of life issues in using the drug. In some embodiments, the keywords may correspond or identify any one or more comments on compliance or adherence to treatment plan, protocol or maintenance in using the drug. In some embodiments, the keywords may correspond to words, phrases, short-hand, abbreviations, spellings/mis-spellings or informal references to the predetermined topic that may be found in user generated content, such as discussions in social networks and discussion platforms.

In some embodiments, a user via a user or web interface to the platform 200 identifies a list of keywords to use for searching sites, including social networks and discussion platforms. In some embodiments, the platform automatically generates or creates the keywords based on the topic. In some embodiments, the platform receives a description of the topic from the user and determines or selects keywords based on the description. In some embodiments, the platform has a library of keywords corresponding to a topic. The platform may use these libraries to lookup or generated keywords for a topic.

At step 304, a list of sites is identified to crawl for finding discussions related to the predetermined topic. The list of sites may include any type and form of social networking sites. The list of sites may include any type and form of discussion platforms. The list of sites may include a domain name. The list of sites may include an Internet protocol address. The list of sites may include a uniform resource locator. The list of sites may include a uniform resource locator to a predetermined resource, location or page of web-site, including any link, hyperlink, section, depth or linked page within the site.

In some embodiments, a user via a user or web interface to the platform 200 identifies a list of sites. In some embodiments, the platform automatically generates or creates the list of sites. In some embodiments, the platform has a predetermined list of sites. In some embodiments, the platform identifies or updates a list of sites based on results from crawling.

At step 306, the web crawling collects data from the crawled sites. Responsive to the list of sites and keywords, one or more web crawlers crawl, search, index and/or collect data from each of the sites. The web crawler may crawl the sites identified by the list of sites, sequentially, in parallel or a combination of both. The web crawler may use the keywords to determine which sites or portions of those sites have matching text, data, meta-data. The web crawler may use the keywords to determine which sites or portions of those sites have text or meta-data matching one or more of the keywords. The web crawler may use the keywords to determine which sites or portions of those sites have user generated data matching one or more of the keywords. The web crawler may use the keywords to determine which sites or portions of those sites have user generated discussions matching one or more of the keywords.

The web crawler(s) may store the matching portions to the data engine. The web crawler(s) may store the matching discussions to the data engine. The web crawler(s) may store the text and meta-data from, corresponding to or associated with the matching portions of the site to the data-engine. The web crawler(s) may store the text and meta-data from, corresponding to or associated with the discussions having text matching one or more keywords. The web crawler(s) may store the text and meta-data from, corresponding to or associated with user generated data matching one or more keywords.

The data, such as user generated data, collected by web crawler(s) from the social networks and discussion platforms provide the initial or “raw” data for the platform in providing and executing the systems and methods described herein. This data may include data that specifies, describes and/or identifies a patient, a name of a patient, email of a patient, user name or login name of the patient, nick name of the patient, geographic location of a patient, drug, name of drug, manufacturer of drug, doctor, hospital, diagnosis, prognosis, treatment, dosage, side-effects, therapies, compliance/non-compliance, adherence/non-adherence and temporal information regarding any of the above. This data may be aggregated, arranged, annotated, analyzed to provide or report on insights, information, statistics, etc, such as identification of clusters, from the online communities regarding the predetermined topic. As such, in some embodiments, patient generated data from online communities may be aggregated, arranged, annotated, analyzed to provide or report on insights, information, statistics, etc. such as identification of clusters, on a predetermined drug and use of the predetermined drug.

At step 308, online communities having relevant discussions on the predetermined topic are identified from the collected data. The platform, such as via web crawler, data engine and/or patient discovery module may identify one or more communities within the crawled sites comprising social networks and discussion platforms. The platform may identify the more or most relevant communities based on a ranking of sites or portions thereof based on keyword matching. The ranking may be based on a number of matching keywords. The ranking may be based on which keywords were matched. The ranking may be based on an external ranking of the quality, number of hits, etc of the site. The ranking may be based on relevance, temporal information and/or volume of discussions. The ranking may be based on number of patients with side-effects or quality of life issues. The ranking may be based on type of side-effects or quality of life issues. The ranking may be based on therapies, treatment plan, dosage, diagnosis, etc. The ranking may be based on location. The ranking may be based on doctors, hospital, insurance or other health care entity provider relationship.

The platform may provide an enumerated list of online communities of or within social networks and discussion platforms. A social network or discussion platform may have a plurality of online communities. Some of these online communities on the same site may be related or associates with the same topic, patient, drug or any of the ranking information described above. The platform may provide an enumerated list of the relevant or most relevant online communities. The platform may provide an enumerated list of the relevant or most relevant online communities based on the ranking The platform may provide an enumerated list of the relevant or most relevant online communities based on meeting a specified or predetermined threshold or criteria, such as a ranking level based on the ranking.

Still referring to FIG. 3A, embodiments of steps of a method for patient discovery is depicted. In brief overview, at step 310, patents are identified from the online communities. At step 312, a survey is designed or generated to target the identified patients. At step 314, the patients are solicited to participate in the survey and the survey is provided to participating patients. At step 316, data is received from the survey and the data is collected and analyzed.

In further detail, at step 310, patients are identified from the online communities. The platform, such as via patient discovery module, may identify patients from the data collected from the web crawler. The platform may identify patients from data maintained or received via the web crawler. The platform may identify patients from data stored via the data engine. The platform may identify patients from discussion data stored via the data engine. The platform may search for data in the discussions identifying that the discussion is from a patient. The platform may search for data in the discussions identifying a patient in the discussion, providing input to the discussion or otherwise associated with or part of a discussion. The platform may search the discussions and identify a name, nick-name, user name or identifier, login name or identifier, account name or identifier, email address, IM name or identifier, twitter name or identifier, social network name or identifier, and/or discussion platform name or identifier.

The platform may present via a user interface, such as the web interface, a listing of each discussion. The platform may highlight, annotate, identify or select one or more data items or text from the discussion that identifies or potentially identifies a patients. A user via the user interface may identify from the discussion the patient. The user may enter via the user interface information on the patient or otherwise annotate, modify or add to the data via the data engine identification of the patient.

At step 312, a survey is designed or generated to target the identified patients. The platform, such as via patient discovery module, may create, design, generate or otherwise provide a survey, such as any embodiments of the survey in FIG. 2D. The platform may provide a user interface, such as a web interface, for a user to design the layout, format and content of survey. The platform may provide a user interface for a user to use templates or a wizard to create a survey. The wizard may prompt the user with a series of questions, comments and/or user input to drive or provide instructions for generating the survey. The platform may automatically generate a survey based on content of discussions from identified patients. The platform may automatically generate a survey based on the keywords used to identify communities. The platform may present the automatically generated survey via a user interface for a user to edit, add, delete or modify elements of the survey. The survey may have user input that corresponds to data items or elements to be collected and stored via the data engine.

A user may review a report of the filtered discussions and based on the report design a survey.

The survey may be designed and constructed to receive input from patients regarding their use of the drug. The survey may be designed and constructed to receive input from patients regarding their quality of life on the drug, such as selection of an index value or a value within a predetermined range. The survey may be designed and constructed to receive input from patients regarding their medical history and/or diagnosis. The survey may be designed and constructed to receive input from patients regarding their treatment plan. The survey may be designed and constructed to receive input from patients regarding their compliance and/or non-compliance with use of the drug, treatment or dosage. The survey may be designed and constructed to receive an indication of consent to the survey and/or providing or releasing medical information. The survey may be designed and constructed to receive an indication of interest to participate in an assessment, such as a clinical trial, study or program.

In some embodiments, instead of or in combination with a survey, the platform may offer a portal, landing page or URL to an interface for self-reporting by any patient, such as any patient or user in the online communities or of any site. A user may create or establish an account with the platform. The user may via the interface of the platform create a profile. The profile may include any data or information that may be identified via or sought by any embodiments of the survey described herein. The data self-reported by the user or patient of the platform may be stored via the data engine. This data collected from the user or patient may be stored with, combined with or used in conjunction with data collected from any surveys.

At step 314, the patients are solicited to participate in the survey and the survey is provided to participating patients. In some embodiments, the platform sends a communication to the identified patient. In some embodiments, the platform posts a communication to the site of the identified patient. In some embodiments, the platform sends a communication to the electronic address, such as an email of the patient. In some embodiments, the platform sends a communication to the user account of the patient at the site. In some embodiments, the platform sends a communication via the discussion at the site used by the patient. In some embodiments, a user via the platform joins the discussion at the site and generates a discussion post regarding the survey. For example, a company or entity sponsoring or providing the survey may join the site (e.g., social network or discussion platform) as a user and may join and participate in the online community.

The communication may request, inquiry or ask whether or not the patient would participate in the survey. The communication may be electronic. The communication may be a physical, such as paper. The communication may describe the purpose, goal or intent of the survey. The communication may describe the data to be collected by the survey. The communication may describe how the patient was identified for the survey. The communication may provide the survey. The communication may provide a link or URL to the survey. The communication may provide instructions for accessing and/or taking the survey. The survey may have an expiration period for completing or being accessible by the patient.

Patients who elect to participate in the survey may access the survey online, such as at a site hosted by or provided by via the platform. The patient may select user interface elements and/or enter user input into the online survey. The patient may select a user interface element of the survey to submit the survey data to the platform. The online survey may submit the content of the survey via a network connection to the platform, such as via HTTP over TCP/IP.

At step 316, data is received from the survey and the data is collected and analyzed. The platform, such as via the patient discovery module or any other module, may receive the data from the surveys. The platform may receive the data in batch mode for a plurality of surveys. The platform may receive the data as the surveys are completed and submitted. The platform may store the data via the data engine. The platform may store the data collected from the surveys in an arrangement, organization or scheme for processing, analyzing and/or reporting on the data.

The platform may establish and/or maintain any metrics of data collected from the surveys. The platform may track and manage the number of surveys distributed and the number of surveys submitted and/or completed. The platform may track and manage the patients who have completed the survey. The platform may track and manage the patients who have not completed the survey. The platform may aggregate, accumulate, tally, compare or other wise process the data collected from the survey to provide an aggregated view of the patients survey results. The platform may segment or categorize the data by any dimension or attribute, including but not limited to patient age, patient gender, patient location, side-effects, compliance, quality of life index, diagnosis, treatment, dosage, length of treatment and medical history.

Referring now to FIG. 3B, an embodiment of steps of a method for using online resources to design a clinical study or trial is depicted. At step 320, a pool of patients are identified to consider for participation in an assessment. At step 322, patients from the pool of patients are selected based on meeting a desired or predetermined selection criteria. At step 324, an assessment is designed and/or generated. At step 326, the assessment is communicated to the selected patients. At step 328, execution of the assessment is monitored and tracked. At step 330, data from monitoring is analyzed and results of assessment determined and communicated.

In further details of step 320, a pool of patients are identified to consider for participation in an assessment. The platform may identify a pool of patients from the patients who submitted the survey. The platform may identify a pool of patients from the patients who were solicited for the survey. The platform may identify a pool of patients from the patients identified in the online community identification phase. The platform may identify patients for the pool of patients via referrals from other patients, doctors and/or other health care related entities. The platform may identify a pool of patients via a query of the data engine.

At step 322, patients from the pool of patients are selected based on meeting a desired or predetermined selection criteria. The platform may select patients from the pool of patients via any one more predetermined criteria. The platform may select patients from the pool of patients based on criteria of age, gender or location of the patient. The platform may select patients from the pool of patients based on criteria of health/medical history of the patient. The platform may select patients from the pool of patients based on criteria of side-effects of the patient. The platform may select patients from the pool of patients based on criteria of diagnosis of the patient. The platform may select patients from the pool of patients based on criteria of quality of life index of the patient. The platform may select patients from the pool of patients based on criteria of diagnosis of the patient. The platform may select patients from the pool of patients based on criteria of treatment plan, treatment length and/or drug dosage of the patient. The platform may select patients from the pool of patients based on criteria of level of compliance or non-compliance. The platform may select patients from the pool of patients based on criteria of level of adherence or non-adherence.

In some embodiments, the platform selects the patients from the online survey that are likely to discontinue using the predetermined drug due to one or more side-effects. In some embodiments, the platform selects the patients from the online survey that exceed a predetermined threshold of risk to discontinue using the predetermined drug due to one or more side-effects. The platform may comprise any logic or algorithm to determine a level of risk of discontinue use of the drug or a level of non-compliance or level of non-adherence. The platform may perform a weighting or function to the data collected from the patient via the online survey to provide a score for a level of risk, level of non-compliance or level of non-adherence. The platform may identify, provide or include a threshold, configurable by the user in some embodiments, to determine if the level of risk, level of non-compliance or level of non-adherence is below or above the threshold.

The platform may present via a user interface, such as the web interface, a pool of patients. The user interface may identify any one or more of the criteria to consider for selection. The user interface may provide sorting, ranking or grouping of the pool of patients. A user may select via the user interface a set of patients from the pool of patients. The selected pool of patients may be stored to the data engine and considered or used for the assessment solicitation and/or execution.

At step 324, an assessment is designed and/or generated. A user may design, generate or otherwise create an assessment, such as clinical trial study, Phase IV trial, an adherence program or a compliance program. The platform may provide a user interface, such as a web interface, to design, create or generate the assessment, including any description and protocols for the assessment. The platform may provide design tool using templates or wizards for designing, creating or generating the assessment. The protocol for the assessment may include or identify any treatment plans, treatment length and drug dosage. The protocol for the assessment may include or identify any therapies to reduce, avoid or eliminate any side-effects. The protocol for the assessment may include or identify any elements of the protocol to increase, improve or sustain adherence or compliance. The protocol for the assessment may include or identify any elements of the protocol to increase, improve or sustain a quality of life index. The protocol for the assessment may include or identify any elements of the protocol in accordance with the diagnosis.

At step 326, the assessment is communicated to the selected patients. In some embodiments, the platform sends a communication to the selected patients. In some embodiments, the platform posts a communication to the site of the selected patients. In some embodiments, the platform sends a communication to the electronic address, such as an email of the selected patient. In some embodiments, the platform sends a communication to the user account of the selected patient at the site. In some embodiments, the platform sends a communication via the discussion at the site used by the selected patient. In some embodiments, a user via the platform joins the discussion at the site and generates a discussion post regarding the assessment. For example, a company or entity sponsoring or providing the assessment may join the site (e.g., social network or discussion platform) as a user and may join and participate in the online community.

The assessment may be designed, intended or used for self or patient management by the selected patient. The assessment may be designed, intended or used for doctor-management of the selected patient. In some embodiments, the assessment is sent to a doctor, health care provider or entity, which may initiate, execute, manage and monitor the assessment via one or more patients. The assessment may be designed, intended or used for both patient-managed and doctor-management of the selected patient.

The communication may request, inquiry or ask whether or not the patient would participate in the assessment. The communication may be electronic. The communication may be a physical, such as paper. The communication may describe the purpose, goal or intent of the assessment. The communication may describe the protocol to be used for the assessment. The communication may describe the data to be collected by the assessment. The communication may describe how the selected patient was selected for the assessment. The communication may provide an electronic copy or version of the assessment. The communication may provide a link or URL to the assessment. The communication may provide instructions for accessing and/or executing the assessment. The assessment may have an expiration period for completing or being accessible by the patient.

At step 328, execution of the assessment is monitored and tracked. The platform, such as via the monitoring module, may monitor, track and manage the execution of the assessment. The platform may provide a user interface, such as a web interface for patients and/or doctors to provide input, comments, feedback and data related to the assessment or protocol thereof. The platform may provide one or more surveys during the assessment execution to obtain data about the execution of the assessment. The platform may send requests, provide reminders or send communications to the patients and/or doctors on a predetermined frequency or time schedule in accordance with the protocol of the assessment. The platform may provide helpful tips, information or comments to the patients and/or doctors. The platform may send partial trial results or results based on events occurring during the trial to the patients and/or doctors. The platform may send changes to the assessment or protocol thereof to the patients and/or doctors.

At step 330, data from monitoring is analyzed and results of assessment determined and communicated. The platform receives data from execution of the assessment. The platform stores the data via the data execution. The platform may receive the data in batch mode for a plurality of assessments. The platform may receive the data as the assessments are completed and submitted. The platform may store the data collected from the assessments in an arrangement, organization or scheme for processing, analyzing and/or reporting on the data.

The platform may establish and/or maintain any metrics of data collected from the assessments. The platform may track and manage the number of assessments initiated or executed and the number of assessments completed. The platform may track and manage the patients who have completed the assessment. The platform may track and manage the patients who have not completed the assessment. The platform may aggregate, accumulate, tally, compare or other wise process the data collected from the assessments to provide an aggregated view of the assessment results. The platform may segment or categorize the data by any dimension or attribute, including but not limited to patient age, patient gender, patient location, side-effects, compliance, quality of life index, diagnosis, treatment, dosage, length of treatment and medical history.

The platform may communicate the results of the assessment to any site, such as an identified community. The platform may post the results to a site. A user of the platform may post the results to or via a discussion on a site. The platform may communicate the results of the assessment to any patient, such as via email to a selected patient. The platform may post the results to a user interface of the platform, such as a web page.

Although the systems and methods of the present solution may be generally described in connection with a drug assessment, the systems and methods are applied to and applicable to any type and form of product assessment, including but not limited to drug, device, biologic, natural health product, over-the-counter product or any type and form of healthcare product (e.g.. tiger balm), and assessment of any type and form of disease, and assessment of any type and form of therapy and/or an assessment of a combination of disease, product and/or therapy.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the invention has been particularly shown and described with reference to specific embodiments, it should be understood by those skilled in the art that various changes in form and detail may be made therein without departing from the spirit and scope of the invention described in this disclosure.

What is claimed:

1. A method for identifying one or more online communities comprising discussions related to patients use of a predetermined drug, the method comprising:
(a) determining, by a device, a plurality of keywords corresponding to a predetermined drug and use of the predetermined drug;
(b) obtaining, by the device, a list of web sites that have one or more online communities comprising discussions generated from web site users about use of one or more drugs;
(c) crawling, by the device, each web site in the list of web sites to match discussions among users within each web site to the plurality of keywords corresponding to the predetermined drug and use of the predetermined drug; and
(d) identifying, by the device, one or more online communities from the list of web sites that have patient generated discussions corresponding to the predetermined drug and the use of the predetermined drug.

2. The method of claim 1, wherein step (a) further comprises determining a keyword of the plurality of keywords that describes a side-effect of the use of the predetermined drug.

3. The method of claim 1, wherein step (a) further comprises determining a keyword of the plurality of keywords related to compliance in the use of the predetermined drug.

4. The method of claim 1, wherein step (a) further comprises determining a keyword of the plurality of keywords that identifies a diagnosis corresponding to the use of the predetermined drug.

5. The method of claim 1, wherein step (b) further comprises obtaining the list of web sites from a user specified configuration.

6. The method of claim 1, wherein step (b) further comprises obtaining the list of web sites from crawling a plurality of web sites.

7. The method of claim 1, wherein step (c) further comprises matching a portion of each web site having web site user generated discussions to the plurality of keywords.

8. The method of claim 1, wherein step (c) further comprises filtering each web site to those web sites having discussions from patients focused on the predetermined drug.

9. The method of claim 1, wherein step (d) further comprises ranking each of the one or more online communities according to relevance of member generated discussions to the predetermined drug and the use of the predetermined drug.

10. The method of claim 1, further comprises identifying the one or more online communities having a relevance exceeding a predetermined threshold to solicit for survey participation.

11. The method of claim 1, wherein step (d) further comprises ranking each of the one or more online communities according to a side-effect from use of the predetermined drug.

12. A method for providing a survey based on online community discussions relevant to use of a predetermined drug, the method comprising:
(a) identifying, by a device, a plurality of patients who are users at one or more online communities and provided patient generated discussions about one or more sides effects from use of a predetermined drug;
(b) generating, via the device, a survey based on the plurality of patients discussions, generated online at the one or more online communities, on use of the predetermined drug;
(c) communicating, by the device, a solicitation to the plurality of patients to participate in the survey; and
(d) receiving, by the device responsive to the survey, data on the predetermined drug from patients participating in the survey.

13. The method of claim 12, wherein step (a) further comprising crawling a plurality of web sites to identify the one or more online communities comprising web site user generated discussions matching a plurality of keywords corresponding to the predetermined drug and use of the predetermined drug.

14. The method of claim 13, further comprising identifying from the discussions at the one or more online communities web site users who use the predetermined drug and provided relevant discussions on use of the predetermined drug.

15. The method of claim 12, wherein step (a) further comprising identifying the one or more online communities providing most relevant discussions about use of the predetermined drug.

16. The method of claim 12, wherein step (b) further comprises designing, via the device, the survey to target collecting information on a patient's side-effect of use of the predetermined drug.

17. The method of claim 12, wherein step (b) further comprises designing, via the device, the survey to target collecting information on a patient's compliance to prescribed use of the predetermined drug.

18. The method of claim 12, wherein step (c) further comprises communicating the solicitation via a network to an electronic contact address of the patient.

19. The method of claim 12, wherein step (c) further comprises posting the solicitation via a network to the one or more online communities.

20. The method of claim 12, wherein step (d) further comprises segmenting, the data received from the survey into one of length of use of the predetermined drug, dosage of the predetermined drug or a side-effect from taking the predetermined drug.

21. The method of claim 12, wherein step (d) further comprises segmenting, the data received from the survey into one of gender or age of the patient.

22. The method of claim 12, wherein step (d) further comprises receiving data from the survey identifying a quality of life index of the patient related to use of the predetermined drug.

23. A method for providing for a drug assessment based on information from patients in online communities, the method comprising:
(a) identifying, by a device, patients from an online survey that indicated interest in participating in an assessment of a predetermined drug;
(b) selecting, via the device based on results from the online survey, the plurality of patients with a predetermined diagnosis and a predetermined side-effect;
(c) generating, via the device, a protocol for the assessment of the predetermined drug based on data collected from the online survey;
(d) communicating, by the device, the protocol to the selected plurality of patients participating in the assessment; and
(e) receiving, by the device, from the selected plurality of patients information on compliance to the protocol and symptom relief from the predetermined side-effect.

24. The method of claim 23, wherein the assessment comprises one of a clinical trial, a compliance program or an adherence program.

25. The method of claim 23, wherein step (a) further comprise identifying the patients from the online survey that are likely to discontinue using the predetermined drug due to one or more side-effects.

26. The method of claim 23, wherein step (a) further comprise identifying the patients from the online survey that exceed a predetermined threshold of risk to discontinue using the predetermined drug due to one or more side-effects.

27. The method of claim 23, wherein step (a) further comprises communicating via a network a request to patients of the one or more online communities to participate in the trial study.

28. The method of claim 23, wherein step (b) further comprises querying, by the device, a database having data collected via the online survey from the plurality of patients from a plurality of online communities.

29. The method of claim 23, wherein step (b) further comprises selecting the plurality of patients who have been using the predetermined drug for at least a predetermined time period.

30. The method of claim 23, wherein step (c) further comprises generating the protocol to prescribe a treatment plan for the predetermined drug.

31. The method of claim 23, wherein step (d) further comprises communicating, by the device via a network, the protocol to a patient at an online community.

32. The method of claim 23, wherein step (e) further comprises submitting, by the patient, via an online site, information on symptom relief based on following the protocol.

33. The method of claim 23, further comprising analyzing the data received from the selected plurality of patents to determine results of the trial study.
